(19) United States
(12) Patent Application Publication
(10) Pub. No.: US 2021/0283000 A1
(43) Pub. Date: Sep. 16, 2021

(54) APPARATUS AND METHOD FOR RELIEVING TIGHTNESS IN THE HIP FLEXOR MUSCLES

(71) Applicant: Kusha Karvandi, Scottsdale, AZ (US)

(72) Inventor: Kusha Karvandi, Scottsdale, AZ (US)

(21) Appl. No.: 17/249,814

(22) Filed: Mar. 15, 2021

Related U.S. Application Data
(60) Provisional application No. 62/989,647, filed on Mar. 14, 2020.

(51) Int. Cl. A61H 1/00

(52) U.S. Cl. CPC A61H 1/006; A61H 2201/0192; A61H 2205/088; A61H 2201/1623; A61H 2203/0456; A61H 2201/1628

(57) ABSTRACT

A massage device for targeting the hip flexor muscle groups. The massage device includes laterally adjustable arcuate massage elements that protrude upwardly from a base. The massage elements may have a variety of curvatures, length, or thickness to impart a desired therapeutic massage. The adjustable Massager allows the user to select the right massage element structure, depth and adjustability, so that they can effectively release their tight hip flexor muscles.

### CROSS-REFERENCE TO RELATED APPLICATION

This application claims the benefit of priority of U.S. provisional application No. 62/989,647 filed Mar. 14, 2020, the contents of which are herein incorporated by reference.

### BACKGROUND OF THE INVENTION

The present invention relates to massage apparatus, and more particularly to massagers for the hip flexor muscle groups.

Sedentary and active individuals often suffer from low back pain caused by tightness from the hip flexor muscles, such as the Psoas.

Other massagers either do not adequately reach the psoas muscles or they are not adjustable in any way to allow the user to precisely target massage of their hip flexor muscles. Without providing the right massage element structure, depth or adjustability, the user cannot effectively release their tight hip flexor muscles.

As can be seen, there is a need for an improved psoas massage device that allows the user to select the right massage element structure, depth and adjustability, so that they can effectively release their tight hip flexor muscles.

### SUMMARY OF THE INVENTION

In one aspect of the present invention, a massage apparatus is disclosed. The massage apparatus includes an elongate base, having a length, a width, and a thickness. A pair of arcuate massage elements have a foot that is adjustably carried on the base for a desired lateral spacing between the pair of arcuate massage elements.

In some embodiments, a rail is defined along a lateral edge of the elongate base. A slot is defined along an inner face of a bottom of the foot.

In some embodiments, a plurality of adjustment slots are defined in a spaced apart relation along at least one of a first end and a second end of the elongate base. An adjustment tab is selectively positionable between an engaged position for cooperative locking engagement of the adjustment tab with a selected one of the plurality of adjustment slots and a free position for sliding adjustment of at least one of the pair of arcuate massage elements along the base.

In some embodiments, the pair of arcuate massage elements are formed of one or more of a thermoplastic, a polymer, an elastomer, or a rubberized material to provide a desired massage element hardness. The massage element hardness may have a Shore durometer of between about 40 A and 90 D selected for a deep tissue massage. Alternatively, the massage element hardness has a Shore durometer of between about 00-30 and 40 A selected for a therapeutic massage.

In some embodiments, the pair of arcuate massage elements have a first arc of between about 70 and 130 degrees across a lateral axis of the base configured for a deep tissue massage. The pair of arcuate massage elements may also have a second arc of between about 70 and 130 degrees across a longitudinal axis of the base.

In other embodiments, the pair of arcuate massage elements have a first radius of curvature of between about 1.5-2.5 inches across a lateral axis of the base configured for a therapeutic tissue massage, more preferably about 2 inches. The pair of arcuate massage elements have a second radius of curvature of between about ⅜ inch to ¾ inch across a longitudinal axis of the base, preferably about ½ inch.

In other aspects of the invention, a massage apparatus includes an elongate base, having a length, a width, and a thickness. A pair of arcuate massage elements protrude upwardly from the elongate base. At least one of the pair of arcuate massage elements have a foot that is adjustably carried on the base for a desired lateral spacing between the pair of arcuate massage elements. The desired lateral spacing is configured to a targeted psoas muscle group.

In some embodiments, a plurality of adjustment slots are defined in a spaced apart relation along at least one of a first end and a second end of the elongate base. An adjustment tab is selectively positionable between an engaged position for cooperative locking engagement of the adjustment tab with a selected one of the plurality of adjustment slots. In a free position the adjustment tab is released for a sliding adjustment of at least one of the pair of arcuate massage elements along the base.

In other embodiments, a rail is defined along a lateral edge of the elongate base. A slot is defined along an inner face of a bottom of the foot, such that the foot is adjustably carried on the base by cooperative sliding engagement of the slot with the rail.

These and other features, aspects and advantages of the present invention will become better understood with reference to the following drawings, description and claims.

### BRIEF DESCRIPTION OF THE DRAWINGS

FIG. 1 is a perspective view of the psoas massage device 20, shown in use, with the user 22 shown in hidden lines for clarity.

FIG. 2 is a top perspective view of the assembled psoas massage device 20.

FIG. 3 is a top perspective of the psoas massage device 20, exploded.

FIG. 4 is a section view of the psoas massage device, taken along line 1-1 in FIG. 1.

FIG. 5 is a section view of the psoas massage device, taken along line 2-2 in FIG. 2.

FIG. 6 is a section view of the psoas massage device, taken along line 2-2 in FIG. 2, illustrating the adjustability of the massage elements 10 with tabs 20 in the unlocked position.

FIG. 7 is a section view of the invention, taken along line 2-2 in FIG. 2, illustrating the adjustability of the massage elements 10 with tabs 20 in the locked position.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provides an apparatus and method for relieving tightness in the hip flexor muscles.

As stated above, sedentary and active individuals often suffer from low back pain caused by tightness from the hip flexor muscles such as the Psoas. Massaging and releasing the psoas muscles can be therapeutic for relieving low back pain and restoring proper movement. The adjustable psoas massager, according to aspects of the invention, makes it easy for the user to adjust to their individual hip width and lay on the device comfortably to release the psoas tightness.

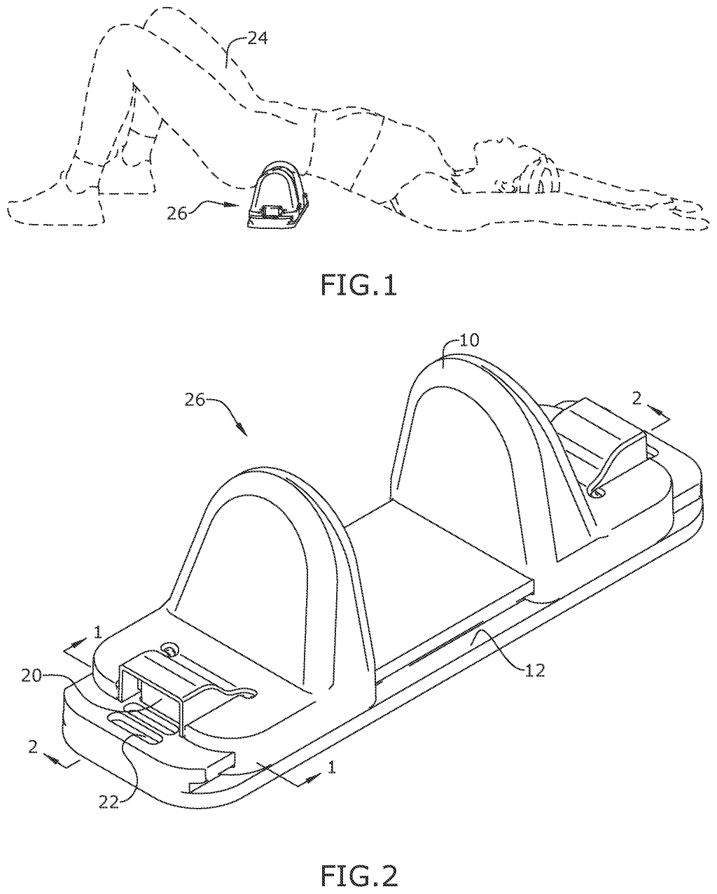

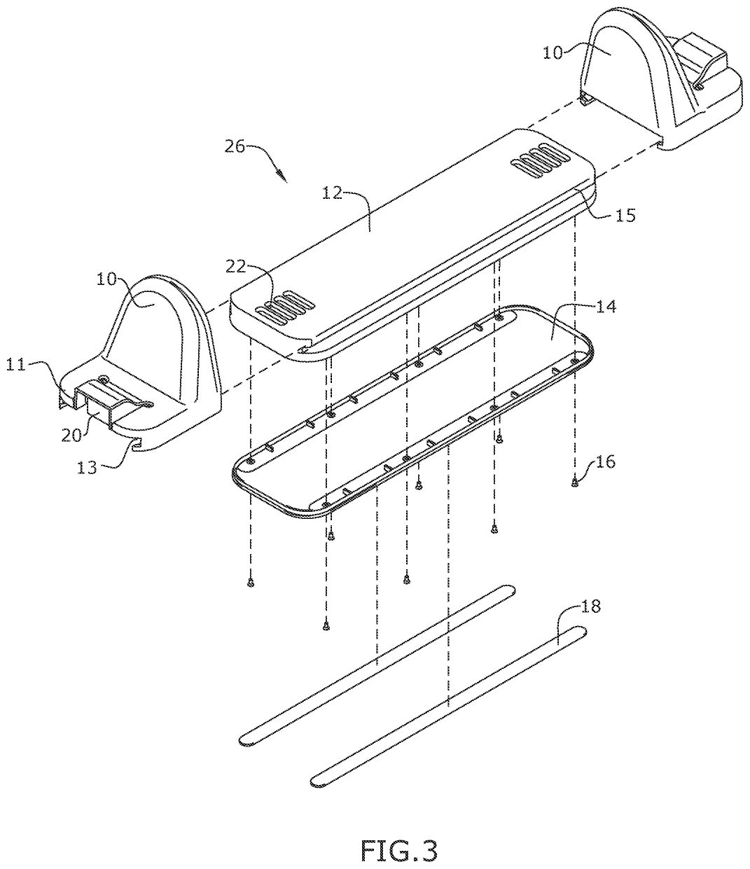

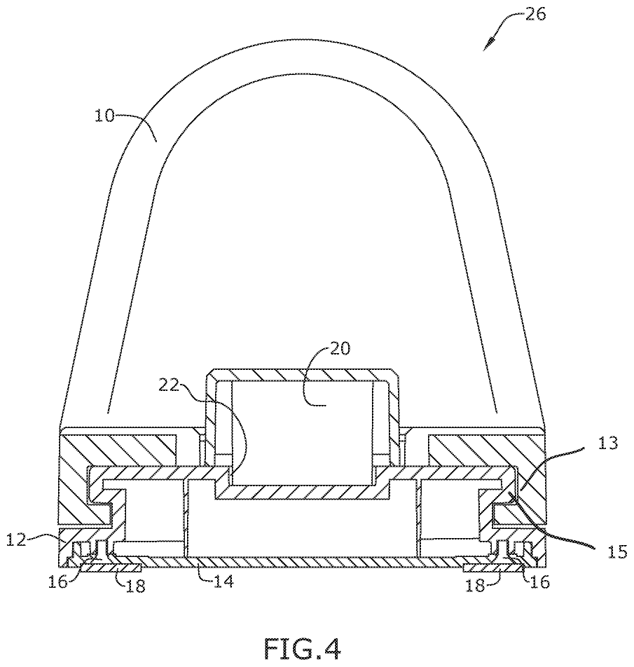

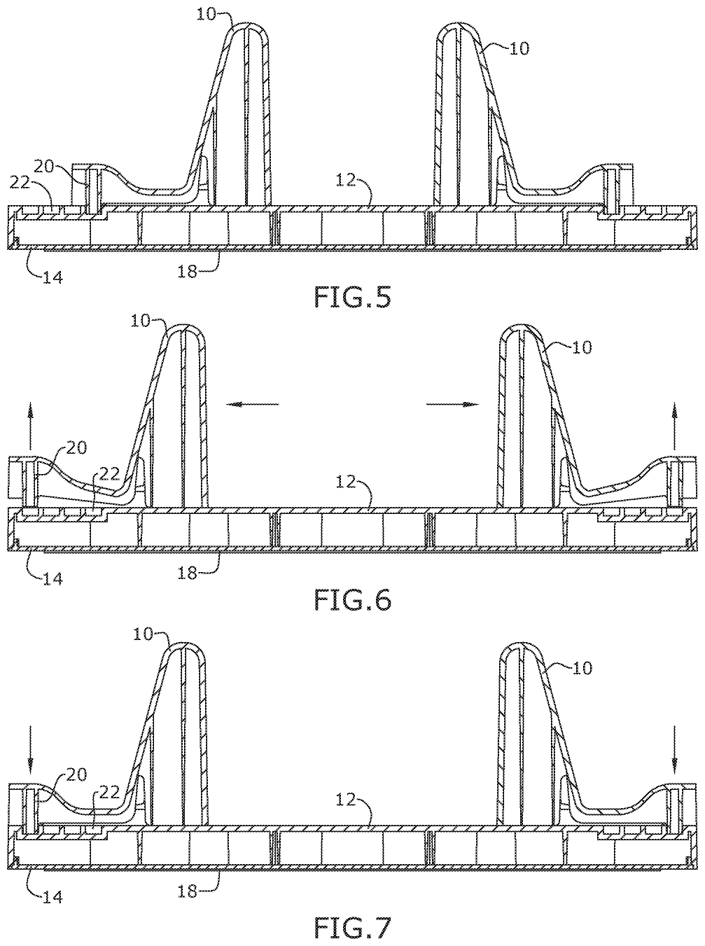

Aspects of the present invention allows the user to select the right massage element structure, depth and adjustability, so that they can effectively release their tight hip flexor muscles. As seen in reference to the drawings of FIGS. 1-7, the psoas massage apparatus 26 of the present may include the following elements: a plurality of arcuate massage elements 10; a base 12; a base cover 14; a fastener 16; a fastener cover strip 18; adjustment tabs 20; a plurality of adjustment slots 22; fully assembled massage apparatus 26; and a user 24.

The massage elements 10 include a massage protrusion extending from an adjustment foot 11. The massage protrusion 10 may be formed in a variety of profiles to a desired curvature, a width, and a depth for a desired therapeutic massage or a deep tissue massage regimen. The adjustment foot 11 is configured for cooperative sliding engagement onto the base 12. By way of non-limiting example, the cooperative sliding engagement may be via a rail 15 and a slot 13 configuration between the adjustment 11 foot and a rail 15 extending along a surface or a side edge of the base 12.

The massage elements 10 provide either a therapeutic or desired deep tissue penetrating massage to a targeted muscle group by selecting the radius of curvature of the massage elements 10 and the hardness of the materials selected for the massage elements 10. To obtain the desired characteristics the massage elements are formed of one or more of a thermoplastics, a polymer, an elastomer, or a rubberized material to provide a desired hardness. Preferably, the massage elements 10 may be formed of a material having a durometer of between about 40 A and 90 D for a deep tissue massage and a durometer of between about 00-30 and 40 A for a therapeutic massage, where the hardness of the material is determined according to ASTM D2240.

Preferably, for a therapeutic massage configuration, the massage elements 10 have a first arch of between about 130 and 200 degrees across a lateral axis of the base 12. The massage elements 10 may have a second arch of between about 130 and 200 degrees across a longitudinal axis of the base 12. For a deep tissue massage, the massage elements 10 have a first arch of between about 70 and 130 degrees across a lateral axis of the base 12. The massage elements 10 may have a second arch of between about 70 and 130 degrees across a longitudinal axis of the base 12. The pair of arcuate massage elements have a first radius of curvature of between about 1.5-2.5 inches across a lateral axis of the base configured for a therapeutic tissue massage, more preferably about 2 inches. The pair of arcuate massage elements have a second radius of curvature of between about ⅜ inch to ¾ inch across a longitudinal axis of the base, preferably about ½ inch.

The base 12 may include a plurality of adjustment slots 22 disposed in a spaced apart relation along at least one of a first end and a second end of the base 12. In the embodiment shown, the plurality of adjustment slots 22 are defined along both the first end and the second end of the base 12. An adjustment tab 20 may protrude from a bottom end of the adjustment foot 11 for engagement with a selected adjustment slot 22 to adjustably position each of the massage elements 10 at a desired lateral displacement. The massage elements 10 may be adjustable through a range of is approximately 4 to 8 inches. The user may set the desired lateral displacement of the massage elements 10 to target a hip flexor muscle group.

A bottom surface of the base may include a base cover 14 that is affixed to the bottom of the base 12. The base cover may be fastened with a plurality of fasteners 16, such as screws pins, or even a snap fit fastener. As will be appreciated the base cover 14 may be coupled to the base 12 via an adhesive or a weld. The bottom surface may also include a strip of frictional material 18 to restrict sliding of the apparatus 26 when in use, and to cover the plurality of fasteners 16 that secure the base cover 14 in order to cover the fastener holes 18.

As previously indicated, the adjustment tabs 20 on the adjustment feet 11 of the massage element 10 are lifted to disengage the adjustment tab 20 from the slot 22. The massage element 10 may then slide laterally on the base 12 so that the user 24 can adjust to their desired width and lay on the massage device 26. The user 24 operatively connects the massage elements 10 to the base 12 and operatively connects the base 12 to the other components for maximum stability and rigidity. As will be appreciated from the present disclosure, the massage elements 10 can be interchanged with other shaped protrusions to provide a different massage benefits and purposes.

A method of using the massage device includes laterally adjusting the width of the massage elements 10 by lifting the adjustment tab 20. Locking the adjustment tab 20 into place into a selected one of the plurality of adjustment slots 22 defined at the ends of the base 12. The user 24 would then lay on the device 26, position the massage elements 10 at a desired muscle group locus in order to release the tightness in their muscles.

It should be understood, of course, that the foregoing relates to exemplary embodiments of the invention and that modifications may be made without departing from the spirit and scope of the invention as set forth in the following claims.

What is claimed is:

1. A massage apparatus, comprising:
an elongate base, having a length, a width, and a thickness; and
a pair of arcuate massage elements having a foot that is adjustably carried on the base for a desired lateral spacing between the pair of arcuate massage elements.

2. The massage apparatus of claim 1, further comprising:
a rail defined along a lateral edge of the elongate base; and
a slot defined along an inner face of a bottom of the foot.

3. The massage apparatus of claim 1, further comprising:
a plurality of adjustment slots defined in a spaced apart relation along at least one of a first end and a second end of the elongate base; and
an adjustment tab selectively positionable between an engaged position for cooperative locking engagement of the adjustment tab with a selected one of the plurality of adjustment slots and a free position for sliding adjustment of at least one of the pair of arcuate massage elements along the elongate base.

4. The massage apparatus of claim 3, wherein the pair of arcuate massage elements are formed of one or more of a thermoplastic, a polymer, an elastomer, or a rubberized material to provide a selected massage element hardness.

5. The massage apparatus of claim 4, wherein the selected massage element hardness has a Shore durometer of between about 40 A and 90 D selected for a deep tissue massage.

6. The massage apparatus of claim 5, wherein the selected massage element hardness has a Shore durometer of between about 00-30 and 40 A selected for a therapeutic massage.

7. The massage apparatus of claim 3, wherein the pair of arcuate massage elements have a first arch of between about 70 and 130 degrees across a lateral axis of the elongate base configured for a deep tissue massage.

8. The massage apparatus of claim 7, wherein the pair of arcuate massage elements have a second arch of between about 70 and 130 degrees across a longitudinal axis of the elongate base.

9. The massage apparatus of claim 3, wherein the pair of arcuate massage elements have a first radius of between about of 1.5-2.5 inches degrees across a lateral axis of the elongate base configured for a therapeutic tissue massage.

10. The massage apparatus of claim 7, wherein the pair of arcuate massage elements have a second radius of curvature of between about ⅜ inch to ¾ inch degrees across a longitudinal axis of the elongate base.

11. A massage apparatus, comprising:
an elongate base, having a length, a width, and a thickness; and
a pair of arcuate massage elements protruding upwardly from the elongate base, at least one of the pair of arcuate massage elements having a foot that is adjustably carried on the elongate base for a desired lateral spacing between the pair of arcuate massage elements, wherein the desired lateral spacing is configured to a targeted psoas muscle group.

12. The massage apparatus of claim 11, further comprising:
a plurality of adjustment slots defined in a spaced apart relation along at least one of a first end and a second end of the elongate base; and
an adjustment tab selectively positionable between an engaged position for cooperative locking engagement of the adjustment tab with a selected one of the plurality of adjustment slots and a free position for sliding adjustment of at least one of the pair of arcuate massage elements along the elongate base.

13. The massage apparatus of claim 12, further comprising:
a rail defined along a lateral edge of the elongate base; and
a slot defined along an inner face of a bottom of the foot, such that the foot is adjustably carried on the elongate base by cooperative sliding engagement of the slot with the rail.
